(19) United States
(12) Patent Application Publication
(10) Pub. No.: US 2022/0268610 A1
(43) Pub. Date: Aug. 25, 2022

(54) IMMERSION PROBES AND RELATED METHODS

(71) Applicant: RdF Corporation, Hudson, NH (US)

(72) Inventor: Robert Gilles van der Heide, Nashua, NH (US)

(73) Assignee: RdF Corporation, Hudson, NH (US)

(21) Appl. No.: 17/675,321

(22) Filed: Feb. 18, 2022

Related U.S. Application Data
(60) Provisional application No. 63/152,271, filed on Feb. 22, 2021.

(51) Int. Cl. G01F 1/688; G01K 7/22; G01F 23/00; G01K 7/02

(52) U.S. Cl. CPC G01F 1/6888; G01K 7/22; G01F 23/0023; G01K 7/023

(57) ABSTRACT

Immersion probes and related methods are generally described. In some embodiments, the probe comprises a shaft with a spiral strake disposed along at least a portion of the length of the shaft and/or a porous shroud extending from a distal portion of the shaft.

### CROSS-REFERENCE TO RELATED APPLICATIONS

This application claims the benefit of priority under 35 U.S.C. § 119(e) of U.S. Provisional Application Ser. No. 63/152,271, filed Feb. 22, 2021, the disclosure of which is incorporated herein by reference in its entirety.

### TECHNICAL FIELD

Immersion probes for measuring a parameter of a fluid and related methods are generally described.

### BACKGROUND

Both immersion probes and thermowells with separate sensors disposed in the thermowell may be used for measuring temperatures and/or other parameters of a fluid. However, thermowells may be used in certain applications, such as high velocity flow applications, where it may be desirable to protect the sensor from the forces applied by the fast flow of fluid where the use of typical immersion probes may be inappropriate. In a flowing fluid, a thermowell may be used in combination with a probe to measure the temperature or other parameter of this flowing fluid. The probe can be placed within the interior sleeve of the thermowell while the thermowell makes direct contact with the flowing fluid. The thermowell may, thus, shield the probe from making direct contact with the flowing fluid which might damage the probe without the protective thermowell in place.

### SUMMARY

Immersion probes for measuring a parameter of a fluid are described herein. The immersion probes may reduce or eliminate vortex shedding when the immersion probes are used to measure a parameter of a flowing fluid. In some embodiments, the immersion probe may comprise a strake that extends along at least a portion of a length of the immersion probe exposed to a fluid flow (e.g., a spiral strake). In some embodiments, the immersion probe may comprise a porous shroud disposed at least partially around a sensing tip of the immersion probe. Depending on the embodiment, these structures may either be combined and/or used separately in various embodiments of an immersion probe.

In one aspect, an immersion probe is described, comprising a shaft having a proximal portion and a distal portion, a strake disposed on and extending along at least a portion of a length of the shaft, and a sensing tip extending from the distal portion of the shaft. In some embodiments, the strake extends along the distal portion of the shaft adjacent to the sensing tip. In some embodiments, the immersion probe comprises a porous shroud extending from the distal portion of the shaft and surrounding at least a portion of the sensing tip.

In another aspect, an immersion probe comprising a shaft having a proximal portion and a distal portion, a sensing tip extending from the distal portion of the shaft, and a porous shroud extending from the distal portion of the shaft and surrounding at least a portion of the sensing tip is described.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand what is disclosed. In the figures:

FIG. 1A shows a schematic of an immersion probe, according to some embodiments;

FIG. 1B is a cross-sectional schematic side view of the immersion probe of FIG. 1A, according to some embodiments;

FIG. 1C is a cross-sectional schematic side view of a distal portion of the immersion probe of FIG. 1A, which schematically illustrates the porous shroud around the sensing tip of the immersion probe, according to some embodiments; and

FIG. 2 schematically illustrates a system in which a fluid flows across an immersion probe extending into the fluid flow, according to some embodiments.

### DETAILED DESCRIPTION

Articles and methods including direct immersion probes are described. The immersion probes described herein may be used to determine a parameter of a fluid (e.g., a flowing fluid). The embodiments described herein may allow the immersion probe to extend into a fluid flow and make direct contact with the fluid without the use of an intervening thermowell or other structure to determine the desired parameter.

With certain conventional temperature probes, a flowing fluid may damage the probe if the velocity or force provided by the fluid is sufficiently high to break or otherwise damage the probe. In order to protect the probe from direct contact with the fluid, conventional temperature probes can be placed within a thermowell, which can protect the temperature probe from, for example, damage from relatively high velocity fluid flows due to the larger diameter of the thermowell providing both increased strength and reduced vortex shedding as compared to the bare temperature probe, or other probe. Thus, the thermowell is inserted into the fluid, and the temperature probe can then be inserted into the thermowell. Once inserted into the thermowell, the temperature probe can determine the temperature of the flowing fluid by being in thermal contact with the thermowell while avoiding direct contact with the fluid.

However, while the use of a thermowell can protect the temperature probe, or other probe, this configuration may present certain disadvantages. For example, the response time of a temperature probe (e.g., within a thermowell) is proportional to the square of a characteristic dimension of the combined system of the temperature probe and the thermowell it is positioned in. Hence, the further away the temperature probe is from the fluid, the slower the response of the probe to changes in the temperature, or other parameter, of the fluid. Thus, the Inventors have recognized that the use of immersion probes result in improved faster response times as compared to thicker thermowells.

While the use of immersion probes may be desirable for decreased response times, the Inventors have recognized another challenge to using immersion probes in certain applications. Specifically, when immersion probes are exposed to sufficiently fast fluid flows for a given design and fluid, vortex shedding from the immersion probe may occur where the flow of fluid against the temperature probe creates vortices within the fluid. This is in comparison to relatively larger diameter thermowells that avoid vortex shedding due to their increased diameter. Without wishing to be bound by any particular theory, if the natural frequency of the probe is less than or approximately equal to the frequency at which vortex shedding occurs, vortex-induced-vibration resonance may occur which may result in greatly accelerated fatigue failure of the probe, and thus, limit the application of immersion probes in these types of applications.

In view of the above, the Inventors have recognized and appreciated within the context of the present disclosure constructions and methods that may be used to reduce the occurrence of vortex shedding on one or more portions of an immersion probe when positioned in relatively high velocity fluid flows. Without wishing to be bound by theory, this may permit the usage of immersion probes in applications that have previously been limited to thermowell based sensing systems. In some embodiments, a strake (e.g., a spiral strake) may be positioned on one or more portions of a shaft of an immersion probe exposed to a fluid flow which may reduce or substantially eliminate vortex shedding of the probe when disposed in the fluid flow. This may allow the immersion probe to make direct contact with a flowing fluid while minimizing vortex shedding. This may also advantageously reduce the distance between the fluid and a sensing tip of the immersion probe which may result in faster more accurate measurements.

As noted above, larger dimensions associated with any probe, including probes positioned within a thermowell or immersion probes, may result in increased response times depending on the particular application. Accordingly, the Inventors have also recognized that in some embodiments, the response time of an immersion probe may be decreased by reducing a maximum transverse dimension of a sensing tip (e.g., a diameter of the sensing tip) that is exposed to a fluid flow relative to a maximum transverse dimension of a shaft of the immersion probe (e.g., a diameter of a shaft of the temperature probe). However, as the sensing tip is reduced in size, the sensing tip may become more susceptible to deformation and fatigue associated with the flow of fluid if left unshielded due to concerns from both the direct force applied to the sensing tip as well as vortex shedding from the smaller dimension sensing tip. Accordingly, in some embodiments, the sensing tip may be at least partially surrounded by a porous shroud that permits the flow of a fluid through the pores of the porous shroud while reducing the forces applied to the sensor tip and reducing vortex shedding from the sensing tip as compared to the unshielded configuration.

While the above embodiments are described separately, it should be understood that in some embodiments, an immersion probe may have both a strake (e.g., a spiral strake) and a porous shroud to advantageously reduce or substantially eliminate vortex shedding and gross deformation of both the overall immersion probe as well as a sensing tip of the immersion probe that may be directly exposed to the fluid.

In addition to the above, depending on the particular application any appropriate sensor may be included in the sensing tip. Appropriate types of sensors may include, but are not limited to a resistance temperature detector, a thermistor, a thermocouple, a thermal dispersion flow sensor, and a thermal dispersion liquid level sensor. Of course, other types of sensors may be included in the disclosed immersion probes as the disclosure is not limited in this fashion.

Various components of an immersion probe and related methods are described in more detail below. It should be understood that these various components as well as their modifications may be used together as the disclosure is not limited to any particular embodiment.

An immersion probe described herein may comprise a shaft. The shaft may form the body of the immersion probe to which a strake (e.g., a spiral strake) may be disposed on. In some embodiments, the strake may extend from a proximal portion of the shaft towards a distal portion, or end, of the shaft. In some embodiments, the shaft is cylindrical in shape and a spiral strake is arranged around the diameter of the cylinder. However, the shaft may have any shape (e.g., conical, elliptical) suitable for the use of the immersion probe. For example, a non-circular shaft may have a non-circular spiral strake that extends around and along at least a portion of a length of the shaft. Thus, the disclosure also is not limited to the shape of the associated spiral strake either.

The length of the shaft may be such that the immersion probe extends an adequate distance into a fluid while providing the immersion probe with the mechanical strength that may be desired to withstand the force applied to the shaft by the fluid as it flows past the shaft. In some embodiments, the length of the shaft is greater than or equal to 1 cm, greater than or equal to 2 cm, greater than or equal to 3 cm, greater than or equal to 4 cm, greater than or equal to 5 cm, greater than or equal to 7 cm, greater than or equal to 10 cm, greater than or equal to 12 cm, greater than or equal to 15 cm, greater than or equal to 20 cm, greater than or equal to 25 cm, greater than or equal to 30 cm, greater than or equal to 40 cm, greater than or equal to 50 cm, or greater. In some embodiments, the length of the shaft is less than or equal to 50 cm, less than or equal to 40 cm, less than or equal to 30 cm, less than or equal to 25 cm, less than or equal to 20 cm, less than or equal to 15 cm, less than or equal to 12 cm, less than or equal to 10 cm, less than or equal to 7 cm, less than or equal to 5 cm, less than or equal to 4 cm, less than or equal to 3 cm, less than or equal to 2 cm, less than or equal to 1 cm, or less. Combinations of the above-referenced range are also possible (e.g., greater than or equal to 1 cm and less than or equal to 50 cm). Other ranges are possible. Those of ordinary skill in the art in view of the teachings of the present disclosure will be capable of selecting a shaft length based on the parameter to be determined and the properties of the fluid to be measured.

In some embodiments, at least a portion of a shaft may be hollow, such that at least a portion of the shaft may contain other components of the immersion probe disposed therein (e.g., one or more wires connected to a sensing tip or a sensor within the sensing tip). In such embodiments, the wall thickness of the shaft may be thick enough to both support any hydrostatic pressure applied to the immersion probe by the surrounding fluid as well as to withstand any bending forces applied to the shaft due to fluid drag.

In some embodiments, a shaft has a maximum transverse dimension (e.g., an outer diameter or other maximum dimension that is perpendicular to a longitudinal axis extending along a length of the shaft) that is greater than or equal to 2 mm, greater than or equal to 3 mm, greater than or equal to 4 mm, 5 mm, 6 mm, 7 mm, 8 mm, 9 mm, 10 mm, 15 mm, or any other appropriate dimension. The maximum transverse dimension of the shaft may also be less than or equal to 20 mm, 15 mm, 10 mm, 9 mm, 8 mm, 7 mm, 6 mm, 5 mm, less than 4 mm, less than 3 mm, less than 2 mm, or any other appropriate dimension. Combinations of the above-referenced ranges are also possible (e.g., greater than or equal to 2 mm and less than or equal to 20 mm). Other ranges are possible.

The shaft may be made from any suitable material. Non-limiting examples of suitable materials include metals (e.g., aluminum, stainless steel, or high-performance alloys), composites, and ceramics. Other materials are possible.

Immersion probes described herein may also comprise one or more strakes disposed on and extending along at least a portion of a length of the shaft exposed to a fluid flow. A strake may take the form of a protruding ridge that extends radially outward from an outer surface of an immersion probe's shaft. The ridge also extends in a direction that is oriented at least partially in a distal direction of the immersion probe towards the distal end of the probe as well as a direction that is perpendicular to the longitudinal axis of the probe such that the strake may form a spiral structure protruding out from the outer surface of the shaft. Depending on the shape of the shaft, the strake may form either a circular or non-circular helix. Additionally, the dimensions such as the pitch, width, height, and other appropriate dimensions of a strake may either be constant or variable along a length of the shaft as the disclosure is not limited in this fashion. In either case, the strake may help to reduce or eliminate vortex shedding that could be caused by the immersion probe being immersed in a flowing fluid.

In some embodiments, a strake extends radially outwards from a surface of the shaft with a particular height. In some embodiments, the height of the strake is greater than or equal to 0.5 mm, greater than or equal to 1 mm, greater than or equal to 2 mm, greater than or equal to 3 mm, or greater than or equal to 4 mm. In some embodiments, the height of the strake is less than or equal to 4 mm, less than or equal to 3 mm, less than or equal to 2 mm, or less than or equal to 1. Combinations of the above-referenced ranges are also possible (e.g., greater than or equal to 0.5 mm and less than or equal to 4 mm). Other ranges are possible.

In some embodiments, the strake height may be measured relative to a maximum transverse dimension of the shaft (e.g., a shaft diameter). In some embodiments, a height of the strake is greater than or equal to 0.05 times, greater than or equal to 0.075 times, greater than or equal to 0.1 times, greater than or equal to 0.125 times, greater than or equal to 0.15 times, greater than or equal to 0.175 times, or greater than or equal to 0.2 times a maximum transverse dimension of the shaft. In some embodiments, a height of the strake is less than or equal to 0.2 times, less than or equal to 0.175 times, less than or equal to 0.15 times, less than or equal to 0.125 times, less than or equal to 0.1 times, less than or equal to 0.075 times, or less than or equal to 0.05 times a maximum transverse dimension of the shaft. Combinations of the above-referenced ranges are also possible (e.g., greater than or equal to 0.05 and less than or equal to 0.2 times a maximum transverse dimension of the shaft). Other ranges are possible.

In some embodiments, the strake has a particular width that may be measured in a direction that is perpendicular to a height of the strake extending outwards from the outer surface of the shaft and that is perpendicular to a direction in which the strake extends along the surface of the shaft. In some embodiments, the width of the strake is greater than or equal to 0.1, 0.2, 0.3, 0.4, 0.5, 0.6, 0.7, 0.8, or 0.9 times a maximum transverse dimension of the associated shaft. In some embodiments, the width of the strake is also less than or equal to 1.0, 0.9, 0.8, 0.6, or 0.5 times the maximum transverse dimension of the shaft. Combinations of the above-referenced ranges are also possible (e.g., greater than or equal to 0.1 and less than or equal to 1.0 times the maximum transverse dimension of the shaft). Other ranges are possible.

For some embodiments a strake may have a particular pitch corresponding to a spacing between adjacent portions of the strake along a length of the shaft. The pitch may either be constant or variable along a length of the strake depending on the embodiment. In some embodiments, the strake has a pitch of greater than or equal to 0.1 cm, greater than or equal to 0.2 cm, greater than or equal to 0.3 cm, greater than or equal to 0.4 cm, greater than or equal to 0.5 cm, greater than or equal to 0.6 cm, greater than or equal to 0.7 cm, greater than or equal to 0.8 cm, greater than or equal to 0.9 cm, greater than or equal to 1 cm, greater than or equal to 1.5 cm, greater than or equal to 2 cm, greater than or equal to 2.5 cm, greater than or equal to 3 cm, greater than or equal to 4 cm, greater than or equal to 5 cm, greater than or equal to 6 cm, greater than or equal to 7 cm, greater than or equal to 8 cm, greater than or equal to 9 cm, or greater than or equal to 10 cm. In some embodiments, the strake has a pitch of less than or equal to 10 cm, less than or equal to 9 cm, less than or equal to 8 cm, less than or equal to 7 cm, less than or equal to 6 cm, less than or equal to 5 cm, less than or equal to 4 cm, less than or equal to 3 cm, less than or equal to 2.5 cm, less than or equal to 2 cm, less than or equal to 1.5 cm, less than or equal to 1 cm, less than or equal to 0.9 cm, less than or equal to 0.8 cm, less than or equal to 0.7 cm, less than or equal to 0.6 cm, less than or equal to 0.5 cm, less than or equal to 0.4 cm, less than or equal to 0.3 cm, less than or equal to 0.2 cm, or less than or equal to 0.1 cm. Combinations of the above-referenced ranges are also possible (e.g., greater than or equal to 0.1 cm and less than or equal to 3 cm). Other ranges are possible.

In some embodiments, the pitch of a strake as it winds around the shaft may be related to a maximum transverse dimension of the shaft. In some such embodiments, the strake has a pitch of greater than or equal to 1 times, greater than or equal to 2 times, greater than or equal to 3 times, greater than or equal to 4 times, greater than or equal to 5 times, greater than or equal to 6 times, greater than or equal to 7 times, greater than or equal to 8 times, greater than or equal to 9 times, or greater than or equal to 10 times a maximum transverse dimension of the shaft (e.g., a diameter of the shaft). In some embodiments, the strake has a pitch of less than or equal to 10 times, less than or equal to 9 times, less than or equal to 8 times, less than or equal to 7 times, less than or equal to 6 times, less than or equal to 5 times, less than or equal to 4 times, less than or equal to 3 times, less than or equal to 2 times, or less than or equal to 1 times a maximum transverse dimension of the shaft. Combinations of the above-referenced ranges are also possible (e.g., greater than or equal to 1 times and less than or equal to 10 times a maximum transverse dimension of the shaft). Other ranges are possible.

The strake can be made of any suitable material. In some embodiments, the material of the strake comprises a metal (e.g., aluminum, stainless steel, or high-performance alloys), a composite, and/or a ceramic without limitation. In some embodiments, the strake is made from the same material as the base material of the shaft. However, embodiments in which a strake is made from a different material that is disposed on and bonded to the shaft are also contemplated as the disclosure is not limited in this fashion. Accordingly, it should be understood that any appropriate method of forming a strake on a shaft may be used including, but not limited to, casting and/or machining a strake into the base material forming a shaft, separate formation and bonding of a strake onto a shaft, and/or any other appropriate method of providing a strake on a shaft as the disclosure is not limited to any particular manufacturing method or construction.

While certain embodiments have one strake extending along the strake, it should be understood that immersion probes described herein may have more than one strake extending along the shaft. That is to say, some embodiments have one or more strakes extending along the shaft (e.g., two strakes, three strakes, four strakes).

In some embodiments, a sensing tip extends from a distal portion of the shaft of an immersion probe. The sensing tip may come into direct contact with a fluid the immersion probe is disposed in. The sensing tip may comprise one or more sensors for measuring or determining any appropriate parameter of the fluid. That is to say, one or multiple sensing tips may extend from the distal portion of a single shaft.

The sensing tip (or a sensor of the sensing tip) may also be electrically connected to one or more wires within the shaft used to communicate with other components of the immersion probe (e.g., a processor, a power source, etc.). In embodiments where sensor response time is not critical, the separate sensing tip may be omitted such that the strake extends to a distal end of the immersion probe with a sensor (or other sensing element) also located at the distal end of the immersion probe. Additional details of the sensing tip are described below.

A sensing tip may have any desired length. In some embodiments, the sensing tip has a length of greater than or equal to 0.1 cm, greater than or equal to 0.2 cm, greater than or equal to 0.3 cm, greater than or equal to 0.4 cm, greater than or equal to 0.5 cm, greater than or equal to 0.6 cm, greater than or equal to 0.7 cm, greater than or equal to 0.8 cm, greater than or equal to 0.9 cm, greater than or equal to 1 cm, greater than or equal to 1.5 cm, greater than or equal to 2 cm, greater than or equal to 2.5 cm, or greater than or equal to 3 cm. In some embodiments, the sensing tip has a length of less than or equal to 3 cm, less than or equal to 2.5 cm, less than or equal to 2 cm, less than or equal to 1.5 cm, less than or equal to 1 cm, less than or equal to 0.9 cm, less than or equal to 0.8 cm, less than or equal to 0.7 cm, less than or equal to 0.6 cm, less than or equal to 0.5 cm, less than or equal to 0.4 cm, less than or equal to 0.3 cm, less than or equal to 0.2 cm, or less than or equal to 0.1 cm. Combinations of the above-referenced ranges are also possible (e.g., greater than or equal to 0.1 cm and less than or equal to 3 cm). Other ranges are possible.

As described elsewhere herein, the response time of one or more temperature sensors may be proportional to the square of a characteristic dimension of the sensing tip relative to a fluid to be measured. Thus, reducing a characteristic size of the sensing tip may improve the response time of the sensor As an illustrative example, an immersion probe may include a sensing tip with a diameter of 1 mm on a shaft with a diameter of 6 mm which could have a 36-fold improvement in response time compared to a probe where the shaft and the sensing tip have the same diameter of 6 mm. Accordingly, in some embodiments, it may be advantageous to have a sensing tip with a relatively small maximum transverse dimension (e.g., a diameter) relative to a maximum transverse dimension of the associated shaft in order to decrease the response time and the accuracy of the temperature reading. That is to say, in some embodiments, a maximum transverse dimension of the sensing tip is less than a maximum transverse dimension of the shaft. For example, a maximum transverse dimension of the sensing tip may be less than or equal to 0.5 times, 0.4 times, 0.3 times, 0.2 times, 0.1 times, and/or any other appropriate fraction of a maximum transverse dimension of an adjacent portion of the shaft. The maximum transverse dimension of the sensing tip may also be greater than or equal to 0.05 times, 0.1 times, 0.2 times, 0.3 times, 0.4 times, and/or any other appropriate fraction of the maximum transverse dimension of the adjacent portion of the shaft. Combinations of the foregoing are contemplated including, for example, a maximum transverse dimension of the sensing tip that is between or equal to 0.05 times and 0.5 times a maximum transverse dimension of the adjacent portion of the shaft. Of course, different maximum transverse dimensions of a sensing tip both greater than and less than those noted above are also contemplated as the disclosure is not limited in this fashion.

A sensing tip may have any desired maximum transverse dimension. In some embodiments, the sensing tip has a maximum transverse dimension of greater than or equal to 0.5 mm, 1.0 mm, 1.5 mm, 2.0 mm, 2.5 mm, 3.0 mm, or any other appropriate dimension. The sensing tip may also have a maximum transverse dimension of less than or equal to 3.5 mm, 3.0 mm, 2.5 mm, 2.0 mm, 1.5 mm, 1.0 mm or any other appropriate dimension. Combinations of the forgoing are contemplated including a sensing tip with a maximum transverse dimension between or equal to 0.5 mm and 3.5 mm. Other ranges are possible.

In some embodiments, it may be desirable for a sensing tip to exchange more heat with the surrounding fluid as compared to a stem of a shaft the sensing tip is connected to. In such an embodiment, a length of the sensing tip may be relatively long as compared to a maximum transverse dimension of the sensing tip. For example, the length of the sensing tip may be greater than or equal to 2, 3, 4, 5, 10, or 15 times greater than a maximum transverse dimension of the sensing tip. The length of the sensing tip may also be less than or equal to 20, 15, 10, 5, 4, 3, or 2 times the maximum transverse dimension of the sensing tip. Combinations of these ranges are contemplated including, for example, the length of the sensing tip may be between or equal to 2 and 20 times the maximum transverse dimension of the sensing tip. Of course, ranges both greater than and less than those noted above are also contemplated.

In some embodiments, a porous shroud may surround at least a portion of the sensing tip of an immersion probe. For example, the porous shroud may, at least partially, obscure a portion, or an entirety, of the sensing tip from the direct flow of fluid past the immersion probe while allowing the sensing tip to come into direct contact with the fluid. To avoid generating a pocket of stagnant fluid within the shroud adjacent to the sensing tip, the porous shroud may have one or more pores, four or more pores distributed around a perimeter of the shroud, or any other appropriate number of pores distributed around a perimeter of the shroud that may permit fluid to flow across the shroud through the pores into the volume disposed between the shroud and the associated sensing tip. In some cases, the porous shroud may have a maximum transverse dimension (e.g., an outer diameter) that is approximately equal to that of the strake and/or shaft, while the sensing tip may have a maximum transverse dimension less than a maximum transverse dimension of the shaft, the strake, and the shroud. Advantageously, the porous shroud may also substantially reduce or eliminate both the drag force applied to the sensing tip as well as vortex shedding induced resonances of the sensing tip as compared to a sensing tip directly exposed to a fluid flow without the shroud. Again, this may permit the usage of a relatively thin sensing tip that would either deform and/or experience accelerated fatigue when exposed to fast fluid flows. In some embodiments, the porous shroud comprises a mesh, an open cell porous foam including a plurality of interconnected pores, a screen, a structure including one or more through holes extending from an exterior surface to an interior surface of the shroud, a structure including one or more round or arbitrary shapes extending from an exterior surface to an interior surface of the shroud, and/or any other appropriate structure capable of providing the desired functionality.

The porous shroud may have an outer maximum transverse dimension (e.g., a diameter) around the sensing tip. In some embodiments, the porous shroud has a maximum transverse dimension of greater than or equal to 0.1 cm, greater than or equal to 0.2 cm, greater than or equal to 0.3 cm, greater than or equal to 0.4 cm, greater than or equal to 0.5 cm, greater than or equal to 0.6 cm, greater than or equal to 0.7 cm, greater than or equal to 0.8 cm, greater than or equal to 0.9 cm, greater than or equal to 1 cm, greater than or equal to 1.5 cm, greater than or equal to 2 cm, greater than or equal to 2.5 cm, or greater than or equal to 3 cm. In some embodiments, the porous shroud has a maximum transverse dimension of less than or equal to 3 cm, less than or equal to 2.5 cm, less than or equal to 2 cm, less than or equal to 1.5 cm, less than or equal to 1 cm, less than or equal to 0.9 cm, less than or equal to 0.8 cm, less than or equal to 0.7 cm, less than or equal to 0.6 cm, less than or equal to 0.5 cm, less than or equal to 0.4 cm, less than or equal to 0.3 cm, less than or equal to 0.2 cm, or less than or equal to 0.1 cm. Combinations of the above-referenced ranges are also possible (e.g., greater than or equal to 0.1 cm and less than or equal to 3 cm). Other ranges are possible. As noted above, in some embodiments, the porous shroud has a maximum transverse dimension equal to a maximum transverse dimension of the strake.

The porosity of the porous shroud may be such that the pores are configured to permit a flow of fluid into the volume surrounding the sensing tip through the shroud at a sufficiently reduced velocity to avoid deformation and/or fatigue failure of the sensing tip for a desired fluid flow. Alternatively, the porous shroud may, without substantially reducing flow velocity, impart sufficient turbulence to the flow so as to suppress vortex formation. In some embodiments, the porous shroud comprises an array or random network of a plurality of pores formed in the porous shroud. In some embodiments, a porosity (i.e. a volume of pores divided by the total volume) of the porous shroud may be greater than or equal to 20%, greater than or equal to 30%, greater than or equal to 40%, greater than or equal to 50%, greater than or equal to 60%, greater than or equal to 70%, or greater than or equal to 80%. In some embodiments, the porosity of the porous shroud may be less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 20% or less than or equal to 90%). Other ranges are possible. The porosity of the material may either be a known material property, calculated from known geometries, optically measured and calculated, and/or it may be measured using a pycnometer or other appropriate density measurement method capable of measuring the density and corresponding porosity of a material including a plurality of open pores.

In some embodiments, the porous shroud can have a particular pore size (e.g., average pore size). In some embodiments, an average maximum transverse dimension (e.g., an average diameter) of the plurality of pores is greater than or equal to 100 μm, 200 μm, 300 μm, 400 μm, 500 μm, 1 mm, or 2 mm. In some embodiments, an average maximum transverse dimension of the plurality of pores is less than or equal to 5 mm, 4 mm, 3 mm, 2 mm, 1 mm, 500 μm, 400 μm, 300 μm, or 200 μm. Combinations of the above-referenced ranges are also possible (e.g., greater than or equal to 100 μm and less than or equal to 5 mm). Other ranges are possible

The porous shroud may be of any suitable material. In some embodiments, the porous shroud comprises a metal (e.g., aluminum, stainless steel, or high-performance alloys). In some embodiments, the porous shroud comprises a ceramic or a composite material. Depending on the particular embodiment, the porous shroud may either be made from the same, or different materials, as the shaft and/or strake of an immersion probe.

The immersion probes described herein may be suitable for a variety of applications. For example, the immersion probes may be used to determine a parameter (e.g., temperature, flow rate, fluid level, or other appropriate parameter) of a fluid flowing through any appropriate structure. The fluid may either be in a liquid, gaseous, or super critical state. The fluid may also be a cryogenic fluid though other temperature fluids including high temperature fluids may also be monitored with the disclosed immersion probes. In some embodiments, the immersion probe can be used as a thermal sensor, a thermal dispersion flow sensor, a thermal dispersion liquid level sensor, and/or any other appropriate type of sensor depending on the desired application. In some embodiments, determining a parameter of a fluid comprises exposing the fluid to the immersion probe (e.g., at least the sensing tip of an immersion probe) and determining the parameter of the fluid based, at least in part, on information from the immersion probe (e.g., one or more sensors of the immersion probe). In some embodiments, an immersion probe is configured to make direct contact with the fluid, for example, before and/or during determining the parameter of the fluid.

Some embodiments may be particularly advantageous for cryogenic applications, where fluids may have a low thermal conductivity, which can make it a challenge to receive fast response times from certain conventional probes. In contrast, the immersion probes described herein may provide decreased response times. However, other applications outside of cryogenic applications, including high temperature applications and high velocity, low density gas flows applications, are also possible.

It is noted that any terms as used herein related to shape, orientation, alignment, and/or geometric relationship of or between, for example, a shaft, a strake, other components, combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, alignment, and/or geometric relationship include, but are not limited to terms descriptive of: shape—such as, round, square, circular/circle, rectangular/rectangle, triangular/triangle, cylindrical/cylinder, cone/conical, elliptical/ellipse, (n)polygonal/(n)polygon, helix/helical, U-shaped, line-shaped, etc.; angular orientations—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; arrangement—array, row, column, and the like. As one example, a fabricated immersion probe that would be described herein as being “square” would not require such an article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

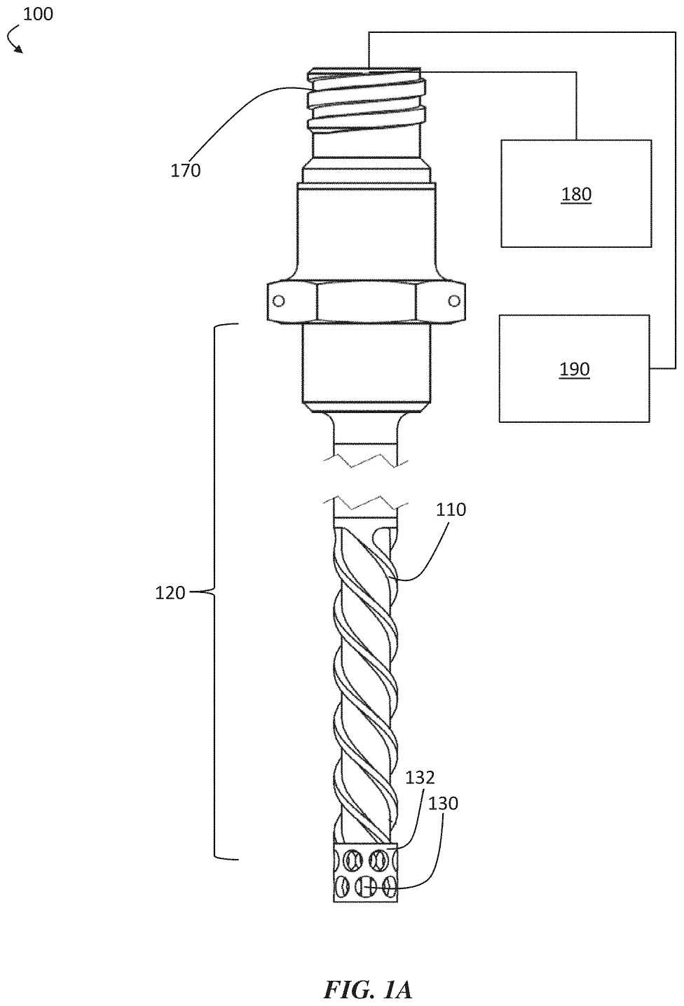

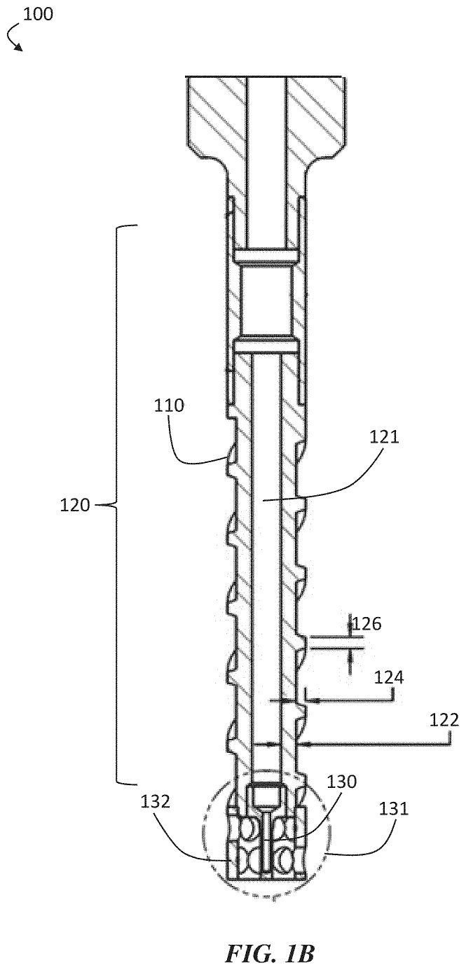

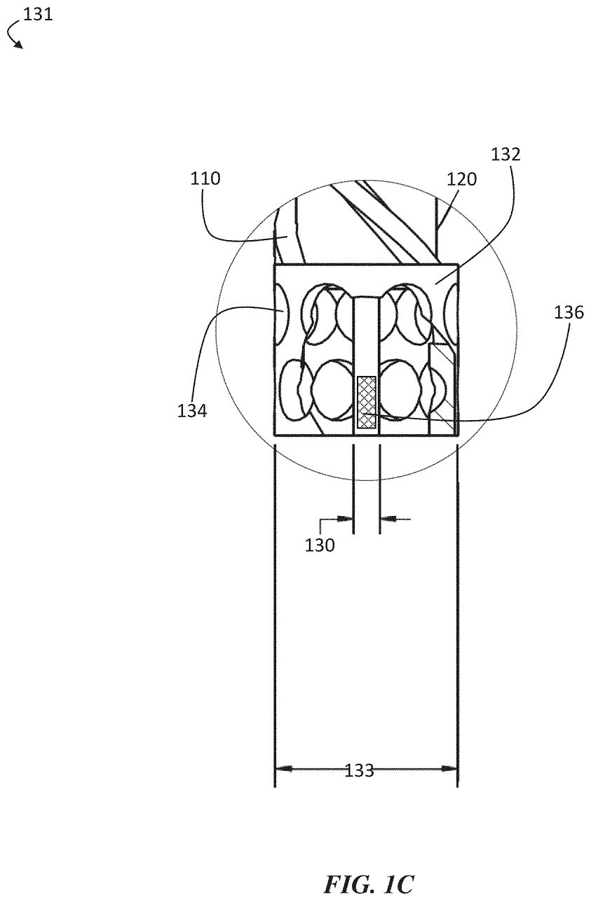

FIG. 1A shows an illustrative schematic of an immersion probe 100. As shown in the figure, a strake 110 extends along the length of a portion of a shaft 120 that is configured to be disposed in a flow of fluid during use. The spiral strake winds around a perimeter of shaft 120 as it extends from a proximal portion of the shaft to a distal portion of the shaft adjacent to a distal end of the shaft. The immersion probe 100 also has a sensing tip 130 extending in a distal direction away from a distal portion of the shaft 120. The sensing tip may be connected to the shaft using welding, brazing, screw threads, adhesives, mechanical interference fits, combinations of the forgoing, and/or any other appropriate type of connection. As best shown in FIG. 1C, the sensing tip has a maximum transverse dimension that is smaller than a maximum transverse dimension of the shaft. The sensing tip is further surrounded by a porous shroud 142 that is connected to and extends distally from the distal portion of the shaft such that the shroud extends around a circumference of the sensing tip while leaving a distal end of the immersion probe open to the fluid in some instances. In some embodiments, a length of the shroud extending distally from the distal portion of the shaft may be greater than or equal to a length of the sensing tip extending distally from the shaft such that a distal end of the sensing tip is either located approximately at or proximally from a distal most end of the shroud. Accordingly, the shroud may at least partially shield the sensing tip from a flow of fluid flowing past the immersion probe. The porous shroud 142 may either be patterned with a plurality of pores formed in the shroud, or the shroud may be formed from a porous material.

The immersion probe 100 may also include one or more threads 170 disposed on a proximal portion of the immersion probe as shown in FIG. 1A for attaching a mounting boss, electrical connector, and/or other structure. Additionally, while FIG. 1A shows threading on the immersion probe, other connections may be used to attach the immersion probe including compression fittings, welds, and/or any other appropriate type of connection as the disclosure is not limited in this fashion.

In some embodiments, the immersion probe may be electrically connected to a processor and/or a power supply, such as the processor 180 and power supply 190 depicted in FIG. 1A. The power supply may provide energy to power the immersion probe, while the processor can be configured to receive an input from the sensing tip (or a sensor disposed within the sensing tip) and output a reading, such as signal related to a temperature, fluid level, flow rate, or other appropriate parameter of a fluid. While a separate processor and power supply have been depicted in the figure, embodiments in which a power supply is not used, as well as embodiments in which power is provided directly from the associated processor, and/or any other appropriate configuration is used are also contemplated as the disclosure is not limited in this manner.

FIG. 1B shows a cross-sectional schematic of the immersion probe shown in FIG. 1A, illustrating additional details of the immersion probe. For example, in the depicted embodiment, the immersion probe 100 is hollow and has an interior volume 121 surrounded by a shaft wall 122 that extends through a distal portion of the shaft that is exposed to a flow fluid during use. As describe elsewhere herein, the hollow shaft may contain additional components of the immersion probe within the volume, such as wires connecting to a power supply and/or processor (not shown).

The spiral strake 110 can extend radially outwards by any desired distance from an outer surface of the shaft, shown as strake height 124 in FIG. 1B. The strake may also have a strake width 126. FIG. 1B also shows the sensing tip 130 extending distally from a distal portion 131 of the shaft 120, the distal portion of which is described in more detail below in FIG. 1C.

FIG. 1C shows a cross-sectional view of the distal portion 131 of the shaft 120 of the immersion probe. Again, the porous shroud 132 extends around an outer perimeter of the sensing tip 130. The shroud also extends distally from the distal portion of the shaft 120 such that the sensing tip extends to a position that is located at, or proximally from, a distal most end of the shroud. A temperature sensor 136, or other sensor, may be disposed in, or may simply form, the sensing tip depending on the particular embodiment. The porous shroud 132 is depicted as having an outer diameter 133 that matches the diameter of the spiral strake 110 where the porous shroud 132 meets the shaft 120 However, shrouds with outer diameters both greater than and less than an outer diameter of the strake and/or shaft are also contemplated. The diameter of the sensing tip 130 is smaller than an inner diameter of the porous shroud 132 such that a gap is present between the shroud and the sensing tip. As shown in the figure, the porous shroud may include one or more pores, such as pores 134. In some embodiments, four or more pores may be disposed around a perimeter of the shroud to permit fluid to flow into the gap between the shroud and the sensing tip through the shroud as well as through an open distal end of the shroud. Due to the direct exposure to the fluid, the sensor 136 may quickly and accurately transmit a signal associated with a desired parameter through one or more wires (not shown) to an associated processor.

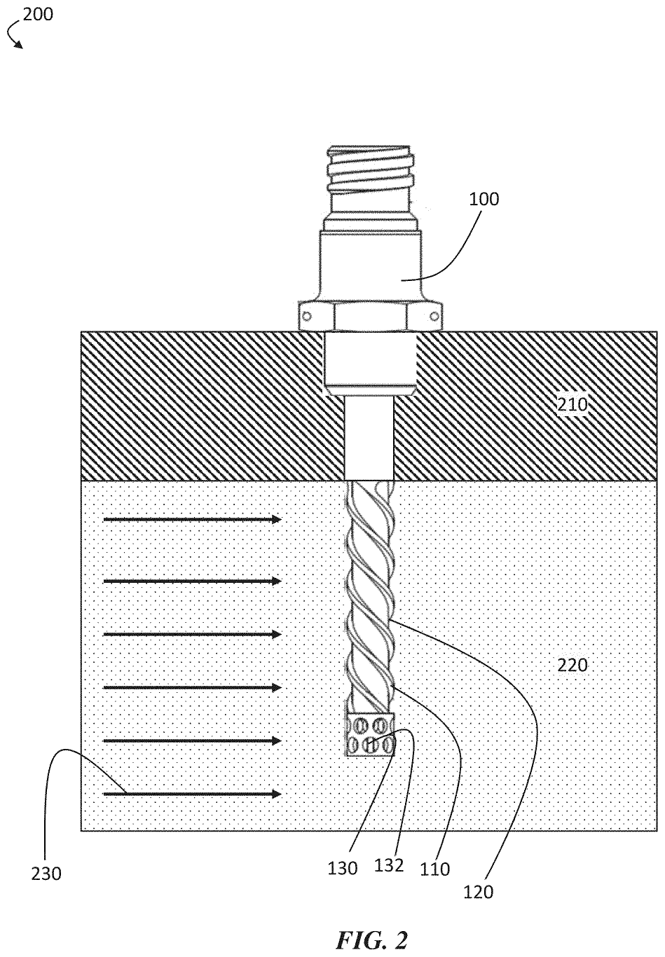

An immersion probe positioned in a system is schematically illustrated in FIG. 2. System 200 shows immersion probe 100 extending through a conduit wall 210 into a flowing fluid 220. Note that the portion of the immersion probe 100 in direct contact with the fluid 220 comprises vortex-reducing features, such as the spiral strake 110 and/or porous shroud 132. These features may reduce or eliminate vortex-induced-vibrations as described in more detail elsewhere herein. The porous shroud 132 may also shield and protect the sensing tip 130 from the direct force of fluid flow 230. As fluid flow 230 passes over immersion probe 100, it can flow through the pores of porous shroud 132 as well as through the open end of the porous shroud at a reduced speed so that the fluid 220 makes direct contact with sensing tip 130 in order to determine a parameter of the fluid 220 (e.g., temperature). Due to the shroud partially shielding the sensing tip, the sensing tip may be exposed to the fluid while not being exposed to the full force of the fluid flow 230. The smaller diameter of sensing tip 130 relative to porous shroud 132 and shaft 120 may allow for the immersion probe 100 to have a relatively fast response time, while the vortex reducing features (e.g., spiral strake 110, porous shroud 132) may allow the immersion probe 100, and the associated sensing tip, to avoid, or at least reduce, vortex-induced resonances. Thus, the system may allow for a parameter of the flowing fluid to be quickly determined while reducing or avoiding vortex-induced vibrations that would likely damage other conventional immersion probes.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An immersion probe, comprising:
a shaft having a proximal portion and a distal portion;
a strake disposed on and extending along at least a portion of a length of the shaft; and
a sensing tip extending from the distal portion of the shaft,
wherein the strake extends along the distal portion of the shaft adjacent to the sensing tip.

2. The immersion probe of claim 1, wherein the strake is a spiral strake.

3. The immersion probe of claim 1, wherein the sensing tip comprises at least one selected from the group of a resistance temperature detector, a thermistor, a thermocouple, a thermal dispersion flow sensor, and a thermal dispersion liquid level sensor.

4. The immersion probe of claim 1, wherein a maximum transverse dimension of the sensing tip is less than a maximum transverse dimension of the shaft.

5. The immersion probe of claim 1, wherein the shaft is hollow.

6. The immersion probe of claim 5, further comprising one or more wires extending through an interior of the shaft, and wherein the one or more wires are connected with the sensing tip.

7. The immersion probe of claim 1, further comprising a power source and/or a processor operatively associated with the immersion probe.

8. The immersion probe of claim 1, further comprising a porous shroud extending from the distal portion of the shaft and surrounding at least a portion of the sensing tip.

9. The immersion probe of claim 8, wherein a maximum transverse dimension of the porous shroud is approximately equal to a maximum transverse dimension of the strake.

10. An immersion probe, comprising:
a shaft having a proximal portion and a distal portion;
a sensing tip extending from the distal portion of the shaft; and
a porous shroud extending from the distal portion of the shaft and surrounding at least a portion of the sensing tip.

11. The immersion probe of claim 10, wherein the porous shroud comprises a plurality of pores.

12. The immersion probe of claim 10, wherein the porous shroud comprises a mesh, a foam, and/or a screen.

13. The immersion probe of claim 10, wherein the porous shroud comprises four or more pores.

14. The immersion probe of claim 10, further comprising a strake disposed on and extending along at least a portion of a length of the shaft;

15. The immersion probe of claim 14, wherein a maximum transverse dimension of the porous shroud is approximately equal to a maximum transverse dimension of the strake.

16. The immersion probe of claim 14, wherein the strake extends along the distal portion of the shaft

17. The immersion probe of claim 10, wherein the sensing tip comprises at least one selected from the group of a resistance temperature detector, a thermistor, a thermocouple, a thermal dispersion flow sensor, and a thermal dispersion liquid level sensor.

18. The immersion probe of claim 10, wherein a maximum transverse dimension of the sensing tip is less than a maximum transverse dimension of the shaft.

19. The immersion probe of claim 10, wherein the shaft is hollow.

20. The immersion probe of claim 19, further comprising one or more wires extending through an interior of the shaft, and wherein the one or more wires are connected with the sensing tip.

21. The immersion probe of claim 10, further comprising a power source and/or a processor operatively associated with the immersion probe.

22. A method for determining a parameter of a fluid, comprising:
flowing a fluid across an immersion probe comprising a shaft disposed in the fluid;
sensing a parameter of the fluid with a sensing tip exposed directly to the fluid, wherein the sensing tip extends from a distal portion of the shaft into the fluid; and
at least partially shielding the sensing tip from the flow of fluid to reduce vibrations induced in the sensing tip by the flow of fluid.

23. The method of claim 22, wherein the shaft includes a strake disposed on and extending along at least a portion of a length of the shaft.

24. The method of claim 22, wherein a porous shroud extends from a distal portion of the shaft and surrounds at least a portion of the sensing tip.

25. The method of claim 22, wherein the parameter comprises temperature, flow rate, and/or fluid level.

26. The method of claim 22, wherein the sensing tip comprises at least one selected from the group of a resistance temperature detector, a thermistor, a thermocouple, a thermal dispersion flow sensor, and a thermal dispersion liquid level sensor.

27. The method of claim 22, wherein a maximum transverse dimension of the sensing tip is less than a maximum transverse dimension of the shaft.

28. The method of claim 22, further comprising transmitting the sensed parameter to a processor.
